(19) United States
(12) Patent Application Publication
(10) Pub. No.: US 2026/0349648 A1
(43) Pub. Date: Nov. 5, 2026

(54) Image-Based Audio Output

(71) Applicant: Bose Corporation, Framingham, MA (US)

(72) Inventors: Thomas David Chambers, Bellingham, MA (US); Todd Richard Reily, North Reading, MA (US); Jenna Marie Duggan-Lykes, Hyde Park, MA (US)

(21) Appl. No.: 19/198,395

(22) Filed: May 5, 2025

(51) Int. Cl. G06F 3/16; G06F 16/783

(52) U.S. Cl. CPC G06F 3/165; G06F 16/7834

(57) ABSTRACT

Various implementations include approaches for audio control based on image data. In some cases, a method includes: obtaining image data from an input; routing the image data through a machine learning (ML) model to determine at least one audio indication of the image data; selecting an audio file or stream based on the at least one audio indication of the image data; and initiating audio output of the audio file or stream at an audio device.

### TECHNICAL FIELD

This disclosure generally relates to audio devices and control functions. More particularly, the disclosure relates to controlling audio output based on image data.

### BACKGROUND

The proliferation of connected devices has enabled enhancement in audio device interface functions, including for example, near real-time responses to voice commands using virtual personal assistants (VPAs). However, in some cases, users struggle to accurately describe audio content of interest via VPAs or other interface commands.

### SUMMARY

All examples and features mentioned below can be combined in any technically possible way.

Various implementations include approaches for audio control based on image data. In some cases, a method includes: obtaining image data from an input; routing the image data through a machine learning (ML) model to determine at least one audio indication of the image data; selecting an audio file or stream based on the at least one audio indication of the image data; and initiating audio output of the audio file or stream at an audio device.

In additional particular aspects, an audio device includes: an electro-acoustic transducer; at least one microphone; and a processor coupled with the electro-acoustic transducer and the at least one microphone, the processor programmed to: rout image data obtained from an input through a machine learning (ML) model to determine at least one audio indication of the image data; select an audio file or stream based on the audio indication of the image data; and initiate audio output of the audio file or stream at the electro-acoustic transducer.

Implementations may include one of the following features, or any combination thereof.

In some cases, the method is performed on a smart device and/or the audio device (e.g., a smart speaker, a home audio system, a vehicle audio system, a wearable audio device, etc.).

In certain examples, the audio indication is an attribute of the image that can be correlated with an audio selection, e.g. with a song, playlist, etc.

In some cases, the audio output is initiated in response to selecting the audio file or stream and without an intervening user command.

In some cases, the image data is obtained at a smart device connected with the audio device.

In some cases, the method further includes: retrieving audio output preferences for a user or a set of users in response to obtaining the image data; and routing the audio output preferences to the ML model to aid in determining the at least one audio indication of the image data.

In certain cases, the audio output preferences include playlist or other music preferences attributed to a music service provider, e.g., an internet or cloud-based music service provider such as a music streaming service.

In some cases, routing the image data and the audio output preferences through the ML model further includes providing a set of instructions to the ML model to select an audio file or stream.

In some cases, the set of instructions are based at least in part on a set of audio device context data.

In certain examples, audio device context data can include one or more of: usage data, device state data (e.g., on/off, outputting audio, sleep mode, listening mode, paired with additional device, etc.), data about the known or likely user (e.g., based on proximity of user device such as smart phone), user profile data, data about location of the audio device (e.g., in the kitchen, living room, outdoors, etc.), data about the type of audio device (e.g., soundbar v. portable audio device v. wearable audio device), time of day, prior and/or last-paired device data, etc.

In some cases, other context data can include user settings, e.g., equalization settings, playlist settings, volume/level settings, pairing settings, etc.

In further cases, context data can be learned from the image data itself, e.g., audio in video data.

Context data can also provide information about vibe, mood, scene, etc., such as beach, hiking, cookout, hanging out in living room, sporting event, walking around a (particular) city, etc.

In certain examples, context data (which can include audio device context data) can be provided with the input (e.g., image data) or ahead of time.

In particular examples, a portion, or all of the context data is provided to the ML model.

In some cases, initiating the audio output is based at least in part on a set of audio device context data.

In some cases, the audio device context data is stored at the audio device or at a connected smart device.

In some cases, the image data includes at least one of photographic data or video data.

In some cases, the method further includes obtaining audio data with the image data.

In some cases, the method further includes adjusting at least one aspect of the audio output based on the audio data. In certain cases, the aspect of the audio output includes volume and/or equalization, and is adjusted based on ambient acoustic conditions.

In some cases, the image data is encoded prior to routing to the ML model.

In some cases, the method further includes: prompting the user to review the audio file or stream, and initiating the audio output based upon a response to the prompt. In certain cases, the response includes an affirmative response, a negative response, or a timeout.

In some cases, the ML model is run on the audio device or a connected smart device.

In some cases, the ML model includes a function-limited operational mode.

In some cases, in response to detecting a threshold latency in network communication, the method includes running the ML model in the function-limited operational mode on the audio device or the connected smart device.

In some cases, the ML model is cloud-based.

In some cases, the method further includes: training a local version of the ML model running at the audio device or a connected smart device with: image data inputs, and audio file or stream outputs from the cloud-based ML model; and running the local version of the ML model in response to receiving subsequent image data after the training. In certain examples, training can include receiving feedback from a user, and refining the local version of the ML model based on the received feedback.

In some cases, the image data is captured at the audio device.

In certain cases, the image data is stored at or otherwise accessible via the audio device and/or a connected smart device.

In some cases, the method further includes prompting a user of the audio device to capture the image data.

In some cases, the ML model includes at least one of, a large language model (LLM) or a large action model (LAM).

In some cases, a smart device is configured to perform the method.

In some cases, the audio device includes a home speaker, a portable speaker, a vehicle audio system, or a wearable audio device.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including at least one audio device, according to various disclosed implementations.

FIG. 2 is schematic data flow diagram illustrating processes in executing control actions based on inputs according to various implementations.

FIG. 3 is a flow diagram illustrating processes in a method of controlling an audio device according to various implementations.

FIG. 4 is a flow diagram illustrating processes in a method of training a machine learning (ML) model according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that commands for audio output can be provided via image data. In particular cases, the approaches include selecting audio file(s) or stream(s) for output based on image data received via an input, which in some cases, is referred to as a user input or an automatic input. In certain of these cases, a machine leaning (ML) model is used to determine an audio indication of image data, and selection of the audio file or stream is based on the audio indication. The various disclosed implementations can enhance the user experience, for example, providing for audio content selection using image data such as photos, videos, etc.

Commonly labeled components in the FIGURES are considered to be substantially equivalent components for the purposes of illustration, and redundant discussion of those components is omitted for clarity. Various features of portable speakers, headsets, and voice controls are described herein, however, additional features of such speakers may be relevant to the disclosed implementations. Such additional features can be described in U.S. patent application Ser. Nos. 18/661,893 (“Machine Learning Based Voice Control for Audio Device,” filed May 13, 2024), Ser. No. 18/835,997 (“Dynamic Portable Speaker Grouping,” filed November 1, 2023), and Ser. No. 18/387,144 (“Audio System Control Device,” filed November 6, 2023), and U.S. Pat. No. 11,521,643 (“Wearable Audio Device with User Own-Voice Recording,” issued December 6, 2022), 10,657,965 (“Conversational Audio Assistant,” issued May 19, 2020), 10,721,560 (“Intelligent Beam Steering in Microphone Array,” issued July 21, 2020), and 10,580,430 (“Noise Reduction Using Machine Learning,” issued March 3, 2020), each of which is incorporated by reference in its entirety.

### System Features

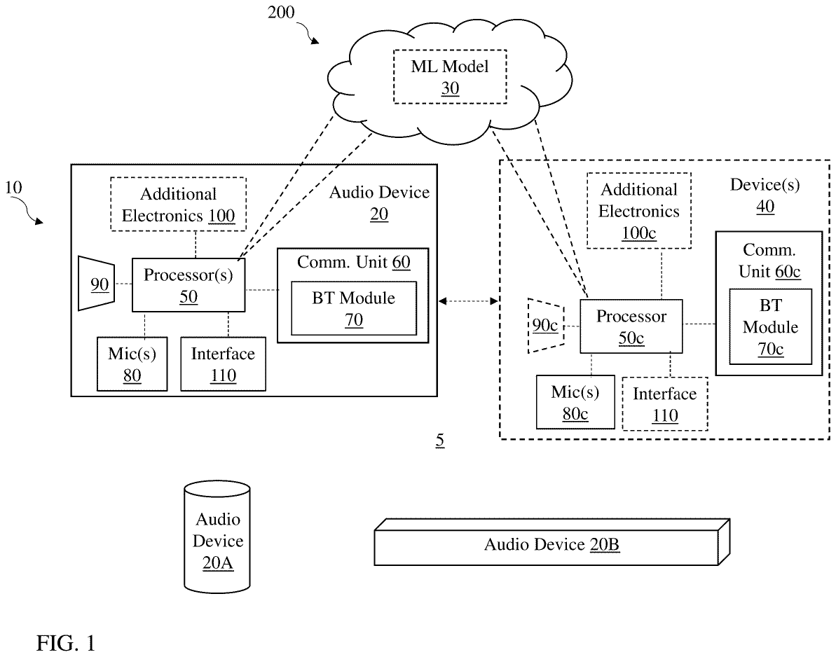

FIG. 1 shows an example of an environment (or, space) 5 including a system 10 with a set of devices according to various implementations. In various implementations, the system 10 is shown including one or more audio devices 20 configured to provide an audio output, e.g., to space 5. In some examples, not depicted, a plurality of audio devices can be located in space 5. As described herein, in various implementations the audio device 20 can include a speaker or a wearable audio device such as a set of headphones or body-worn speakers. In certain examples, the audio device 20 includes a fixed or portable speaker. In certain cases, a portable speaker includes a portable loudspeaker such as a portable smart speaker, a portable home speaker, or a portable public address (PA) system. In certain cases, one or more audio devices 20 is configured to facilitate voice control using a machine learning (ML) model 30. As described herein, the ML model 30 can be run (operated and/or stored) locally at the audio device 20 and/or at another device 40 in the space 5. In additional cases, the ML model 30 is run (e.g., operated and/or stored) in a remote or distributed computing system such as a network or cloud-based platform. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In one example implementation, another device 40 such as a smart device can be located in the space 5 and can be configured to communicate with the audio device 20 according to various implementations. In certain examples, device 40 can include a communications device, an audio gateway device, a computing device, etc. In various implementations, device 40 is a personal electronic device such as a smart phone, smart watch, or tablet computing device.

In certain cases, the audio device 20 is capable of being connected with device 40 and/or another device such as an additional audio device 20, a charging hub, an amplifier, a home entertainment system, etc. Two or more devices (e.g., audio device 20 and device 40) can communicate with one another using any communications protocol or approach described herein.

One or more of the audio devices 20 can include a portable speaker, such as a portable home speaker. It is understood that a “portable speaker” or a “portable home speaker” as described herein can refer to any of a number of speakers that are configured for wired and/or wireless operation, and are configured to change location. One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc.

In certain cases, the audio device 20 includes one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50, the audio device 20 can also include one or more microphones 80 (e.g., a microphone array), and a transducer 90 (e.g., an electro-acoustic transducer) for providing an audio output, e.g., in space 5. Further, the audio device 20, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, additional devices 40 such as smart phones, smart watches, tablets, etc. in space 5 can include similar components (e.g., a processor 50 and communications unit 60) as the audio device 20. Further, those additional devices 40 can include additional components that may not necessarily be present at the audio device 30. Additional device(s) 40 can be configured to communicate with any device described herein.

Also shown in FIG. 1, one or more audio devices 20 and/or devices 40 can include an interface 110. In some cases, the interface 110 is a physical interface on the body of the device, although this is not necessary in all implementations. In certain cases, the interface 110 can include a touch screen, button, dial, slider, etc., that is configured to control one or more attributes of the audio device 20 (or devices 40) in a plurality of modes. As described herein, the audio device 20 and/or the device 40 can be referred to as an audio capture device, e.g., including a microphone 80 that is configured to capture audio from the space 5, e.g., a voice command from a user in the space 5, ambient acoustic conditions, etc.

The audio device 20 can be configured to output audio from an audio source. In some cases, the audio source can include an audio gateway device such as device 40. In additional cases, the audio device 20 can be configured to output audio from an audio source via a network, cellular, and/or cloud-based connection, e.g., via a streaming music service, an internet radio station, a stored audio file library, etc. In various implementations, the audio device 20 can be referred to as a “smart” device that has network and/or cellular connectivity, and in certain cases, operate or otherwise execute virtual personal assistant (VPA) functions.

### Image-Based Control

In particular cases, the processor(s) 50 may, for example, enable image-based control of one or more audio output parameters using ML model 30. In certain cases, the ML model 30 is at least partially located at the audio device 20 and/or the device 40 in the space 5. For example, the ML model 30, or a version thereof, can be run or otherwise stored or operated locally at the audio device 20 and/or the device 40. In additional implementations, the ML model 30 is stored, operated, updated, or otherwise managed in a remote location 200, such as a centralized or distributed computer network or a cloud-based computer network or system. In particular implementations, the ML model 30 is periodically updated in the remote location 200, e.g., with training and/or refinement data. In certain cases, the ML model 30 is configured to be run at the remote location 200. In additional cases, a distinct, local version of the ML model 30 is configured to be stored and/or run at the audio device 20 and/or device 40.

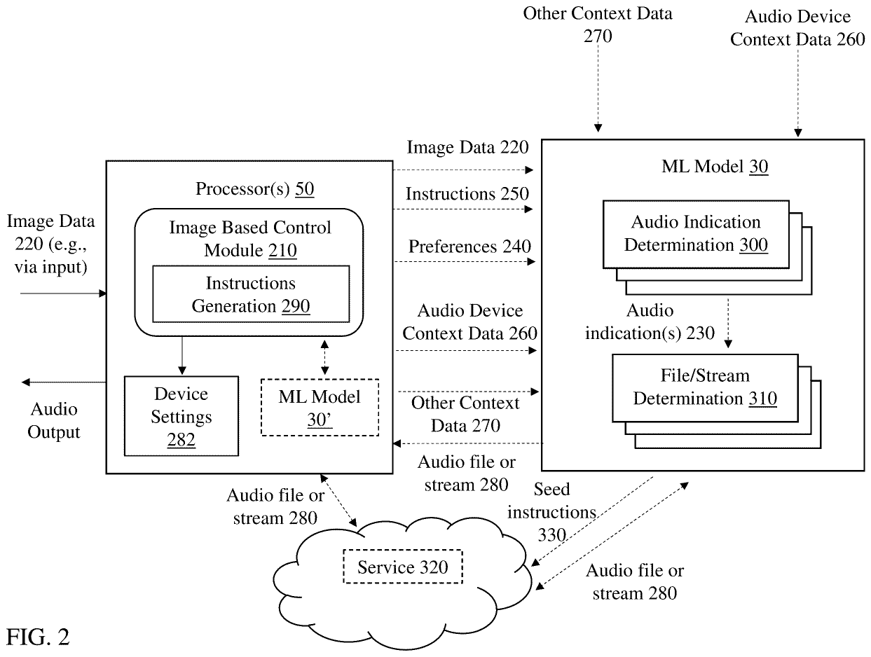

In various implementations, processor(s) 50 in audio device 20 and/or device 40 include an image data-based control module 210 (FIG. 2) which can include software and/or hardware for performing control processes described herein. For example, processor(s) 50 can include an image data-based control module 210 in the form of a software stack having instructions for controlling (e.g., adjusting) one or more aspects of the audio output (e.g., an audio file or stream) based on interaction with the ML model 30 and image data (e.g., obtained from an input) according to any implementation described herein.

FIG. 2 is a schematic data flow diagram illustrating interaction of the processor 50 including an input (e.g., image) based control module 210 that interfaces with the ML model 30 to determine at least one audio indication 230 of image data 220 provided via input (e.g., a user input or any other image data input such as an automatic input from captured image data and/or stored image data), and select an audio file or stream 280 for output based on the audio indication(s) 230. In particular implementations, the ML model 30 includes an artificial intelligence engine that includes one or more neural networks, e.g., advanced neural networks (ANNs). In one example, the neural network(s) include a temporal convolutional network (TCN) and/or a convolutional long short term memory (ConvLSTM) network. In particular implementations, the ML model 30 includes a large language model (LLM) and/or a large action model (LAM) that is configured to determine at least one audio indication 230 of the image data 220 In particular cases, the ML model 30 includes one or more models with a set of non-linear pathways defined as sequences of steps between distinct sets of parameters.

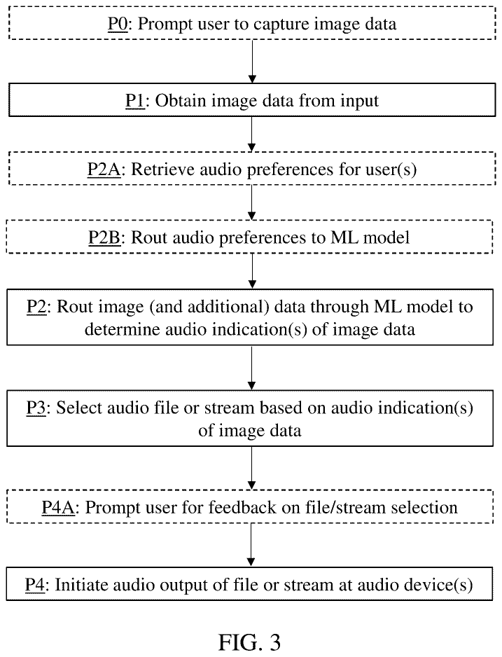

With continuing reference to FIG. 2, and additional reference to the process flow diagram in FIG. 3, approaches according to various implementations can include:

P1: obtaining image data 220 from an input. In some cases, the image data 220 includes at least one of photographic data or video data. In particular cases, the image data 220 includes a photograph and/or video captured by the user, stored at a device (e.g., audio device 20 and/or device 40), and/or otherwise retrieved via a device (e.g., audio device 20 and/or device 40 via a network or other connection). In some cases, the image data 220 is obtained at a smart device (e.g., device 40) that is connected with the audio device(s) 20. In other cases, the image data 220 is captured at the audio device 20, e.g., where the audio device 20 includes a camera. In some optional example implementations (illustrated in phantom as P0), prior to obtaining the image data 220, the method further includes prompting a user of the audio device 20 to capture the image data, e.g., via the audio device and/or another connected device 40. In some cases, the prompt can be delivered via interface 110. In certain examples, the user takes an action to provide the image data 220 as an input, e.g., via an interface at the audio device 20 and/or device 40. In additional examples, the image data 220 can be obtained without requiring user action, e.g., automatically from captured image data at device 40 and/or audio device 20 and/or stored or otherwise accessible image data 220 via the device 40 and/or audio device 20. In further implementations, image data 220 can be obtained as an input during a certain operating mode of the audio device 20 and/or device 40, e.g., when an application such as the image based control module 210 is running.

P2: routing the image data 220 through ML model 30 to determine at least one audio indication 230 of the image data 220. In certain examples, the audio indication 230 is an attribute of the image that can be correlated with an audio selection, e.g. with a song, playlist, etc. In various non-limiting examples, attributes of the image can include indicators of a location (e.g., image(s) of a beach, poolside, snow or ski environment, kitchen, sporting event, transit environment, etc.), social situation (e.g., one or more people in the image(s), groups of people, crowds, etc.), weather (e.g., sunny day, cloudy day, snowy day, rainy day, etc.), time of day (e.g., evening, morning, etc.), as well as one or more supplemental indicators such as objects in the image (e.g., musical instruments, coffee cups, cocktail glasses, cooking utensils, footwear, sporting equipment, vehicle presence and/or type, etc.). In particular cases, the ML model 30 is configured to rank or otherwise weight attributes of image data to select one or more audio indications 230, e.g., placing greater weight on certain type of attributes and less weight on others. Further, additional attributes of the image data 220 can be used in the weighting, e.g., image quality, filter(s) on the image (e.g., black/white, saturated, high contrast, etc.), blur or artifacts, text in the image (e.g., in the environment), metadata for the image (e.g., a timestamp or location data), etc.

In some optional cases, the image data 220 is encoded prior to routing to the ML model 30. As described herein, additional data can be routed through the ML model 30 with the image data 220 to aid in determining audio indication(s) 230.

Additional optional implementations (P2A-P2B), shown in phantom, include retrieving audio output preferences 240 for a user or a set of users in response to obtaining the image data (P2A), and routing the audio output preferences 240 to the ML model 30 to aid in determining the audio indication(s) 230 of the image data 220 (P2B). Processes P2A and P2B can be performed concurrently with process P1, or at a different time. In certain cases, the audio output preferences 240 include playlist or other music preferences attributed to a music service provider 320, e.g., an internet or cloud-based music service provider such as a music streaming service 320. The ML model 30 and/or processor 50 can communicate with the service 320 to send/receive service functions, as well as audio output preferences, among other data.

In some example cases, routing the image data 220 and the audio output preferences 240 through the ML model 30 further includes providing a set of instructions 250 to the ML model 30 to select an audio file or stream 280. According to some implementations, the set of instructions 250 are generated by the control module 210 (e.g., instructions generation 290) at processor 50, and are based at least in part on a set of audio device context data 260 (which may be provided separately, as shown in phantom). Audio device context data 260 can include one or more of the following non-limiting examples: usage data about audio device 20, device state data about audio device 20 (e.g., on/off, outputting audio, sleep mode, listening mode, paired with additional device, etc.), data about the known or likely user of audio device 20 (e.g., based on proximity of user device 40 such as a smart device), user profile data for the audio device 20 and/or a connected device 40, data about location of the audio device 20 (e.g., in the kitchen, living room, outdoors, etc.), data about the type of audio device 20 (e.g., soundbar v. portable audio device v. wearable audio device), time of day, prior and/or last-paired device data such as device 40, etc.

In some cases, other context data 270 is used to aid in selecting the audio file or stream 280. According to some examples, other context data 270 can include user settings, e.g., equalization (EQ) settings, playlist settings, volume/level settings, pairing settings, etc., for the audio device 20. In further cases, context data 270 can be learned from the image data 220 itself, e.g., audio in video data. For example, the audio data captured in an image and/or in a multi-frame photo can provide context for user settings. In one example, where a user captures image data 220 in real time or at a proximal time to selection of the audio file or stream 280, the audio data can provide contextual cues for the ambient acoustic conditions, e.g., the level (volume) of ambient noise in the environment around the user at the time of capturing the image data 220, whether dialogue is present, whether many voices can be heard to indicate a gathering, whether acoustic signatures are present indicating an environment (e.g., an acoustic signature such as the hum of an engine or the sound of a whistle), etc. Further, detecting mixed voice inputs (e.g., from multiple people) can indicate a gathering such as a party or social event is underway, and can be used to select a relatively more upbeat or active music vibe/output. In particular examples, context data 270 can also provide information about vibe, mood, scene, etc., such as beach, hiking, cookout, hanging out in living room, sporting event, walking around a (particular) city, etc. In certain examples, context data (which can include audio device context data 260 and/or additional context data 270) can be provided with the input (e.g., image data 220), or ahead of time. In particular examples, a portion, or all of the context data (e.g., audio device context data 260 and/or additional context data 270) is provided to the ML model 30.

Returning to FIG. 3, after routing the image data 220 through the ML model 30, the method can further include, in process (P3): selecting an audio file or stream 280 based on the at least one audio indication 230 of the image data 220. The audio file or stream 280 can be selected using the neural networks(s) of the ML model 30. In some cases, distinct sub-networks are used to determine audio indications 230 (e.g., audio indication determination 300) as compared with selecting the audio file and/or stream (e.g., file/stream determination 310). In other cases, these networks are integrated or otherwise connected to perform these functions within ML model 30. In certain additional implementations, functions of the ML model 30 can be integrated with the service 320.

In additional examples, the ML model 30 is configured to choose a closest title and/or artist of an audio file (e.g., a track or song) based on the audio indication(s) 230, and use the audio file (or a set of files) as the seed for a playlist (e.g., audio file or stream 280) to be generated by the service 320. The playlist can be generated using the seed file (or group of files, or songs) selected by the ML model 30, and in some cases, without notifying the user of which audio file or files are used to seed the playlist. In these examples, the user may only hear (and in some cases, see, via an interface 110 at audio device 20 and/or device 40) the playlist generated by the service 320, without specific knowledge of the file/files (e.g., audio tracks) at the origin of that playlist. In these implementations, the ML model 30 may choose a single audio file or a set of two or more audio files (e.g., audio file 280) and seed the playlist using service 320. In certain cases, as shown in FIG. 2, the seed file, song, or set of songs can be provided to the service 320 as a set of seed instructions 330, which can include a command to generate an audio file or stream 280 based on the seed file(s) or song(s). In additional cases, the instructions 330 can accompany a selected audio file 280 provided by ML model 30. In one example, the ML model 30 provides seed instructions 330 to the service 320 that include, or accompany, a selected audio file or stream 280, the instructions asking for a playlist to be generated from the seed file or stream. These approaches can allow the ML model 30 to efficiently generate a playlist using the seed song(s), while relying on the existing library and playlist generation approaches of a service 320.

Following selection of the audio file or stream 280, in process (P4), the processor 50 is configured to initiate audio output of the audio file or stream 280 at an audio device, e.g., one or more audio device(s) 20 in space 5. In some cases, the audio output is initiated automatically, for example, in response to selecting the audio file or stream 280 and without an intervening user command. In some cases, initiating the audio output is based at least in part on the audio device context data 260, which in certain cases, is stored at the audio device 20 and/or at a connected smart device (e.g., device 40).

In certain cases, the processor 50 is configured to apply one or more adjustments and/or settings determinations to the audio file or stream 280 based on image data 220, audio device context data 260, and/or additional context data 270. In various implementations, audio data can provide context for the EQ settings, playlist settings, volume/level settings, pairing settings., etc. In various implementations, the processor 50 is configured to adjust at least one aspect of the audio output based on the audio data. In certain cases, the aspect of the audio output includes volume and/or equalization, and is adjusted based on ambient acoustic conditions. For example, the processor 50 can be configured to select a higher level (e.g., volume) and/or a particular EQ setting when relatively higher levels of noise are detected (e.g., in audio data with image data 220, and/or in context data 270). Further, mixed voice inputs and/or noise level may indicate a relatively larger group of people in an environment, and may suggest that grouping multiple devices for audio output is beneficial (e.g., where two or more audio devices 20 are in an environment or proximate one another). In these cases, the processor 50 can be configured to group audio devices 20 for output to an environment (e.g., environment 5, FIG. 1) based on detecting an indicator of a social gathering and/or a high level of ambient noise. Further, audio device data 260 and/or additional data 270 can provide indicators of beneficial device grouping, e.g., in user profile settings, existing pairings between devices 20, etc. Additional examples of grouping and/or multi-device controls are described, e.g., in U.S. patent application Ser. Nos. 18/387,144 and Ser. No. 18/385,997, previously incorporated by reference herein.

In some implementations, the processor 50 can be configured to select audio device settings 282 for output of the audio file or stream 280 based on the audio device context data 260 and/or additional context data 270, e.g., after the audio file or stream 280 has been returned from the ML model 30. For example, the processor 50 can be configured to use the audio device context data 260 and/or additional context data 270 to select audio device settings 282 for output of the selected audio file or stream 280, e.g., to select a volume (level), EQ settings, speaker grouping, channel selection, etc.

With continuing reference to FIG. 3, in an additional optional implementation, the process can further include (in process (P4A)) prompting the user to review the audio file or stream 280 (P4A), and initiating the audio output based upon a response to the prompt (P4). In particular implementations, the prompt and/or response can be provided via any interface 110 at the audio device 20 and/or connected device 40, e.g., a voice prompt/response, visual prompt/response at a display, tactile prompt/response at a touch interface, etc., In certain cases, the response includes an affirmative response, a negative response, or a timeout. In certain cases, the prompt is provided with the initiated audio output (concurrently with P4), or prior to initiating the audio output in process P4.

In various implementations, one or more processes in the method (e.g., illustrated in FIG. 3) are performed on a smart device (e.g., device 40) and/or the audio device(s) 20. In certain cases, processes are performed at a smart device 40 and/or audio device 20 such as a smart speaker, a home audio system, a vehicle audio system, a wearable audio device, etc.).

In some particular examples, the ML model 30 is run on the audio device 20 or a connected smart device (e.g., device 40). In certain cases, the ML model 30 includes a function-limited operational mode. In particular examples, in response to detecting a threshold latency in network communication, a method includes running the ML model 30 in the function-limited operational mode on the audio device 20 or the connected smart device 40. In these cases, a function-limited operational version of the ML model 30 can be periodically stored and/or updated at the audio device 20 and/or smart device 40 with the ability to run offline, i.e., without a network communication to the full ML model 30. This function-limited version of the ML model 30 can also be referred to as a local version of the ML model, and is illustrated as ML model 30′ in FIG. 2. In certain of these cases, the complete ML model 30 (or, a version that is not function-limited) is run remotely, e.g., as a cloud-based model.

In certain cases, the processor 50 is configured, in response to detecting a threshold latency in network communication, to run the ML model 30′ in the function-limited operational mode on the device(s) 20, 40 to improve the efficiency in the response to the input 220. For example, the processor 50 can be configured to monitor network communication latency, and in response to the detected latency satisfying a latency threshold, run the function-limited ML model 30′ locally to determine the intended control action for the audio device 20. In still further implementations, the function-limited ML model 30′ can be run as a default if user login credentials are not provided or are otherwise not authenticated for a service 320 (e.g., music or other audio file/stream service). In such cases, the function-limited ML model 30′ can also be selected according to user profile settings and/or device setup. For example, if a user sets up the audio device 20 without providing credentials for a service 320, the processor 50 can be configured to default to ML model 30′ in future uses, and/or provide a prompt to enter the credentials for service 320 in a subsequent use.

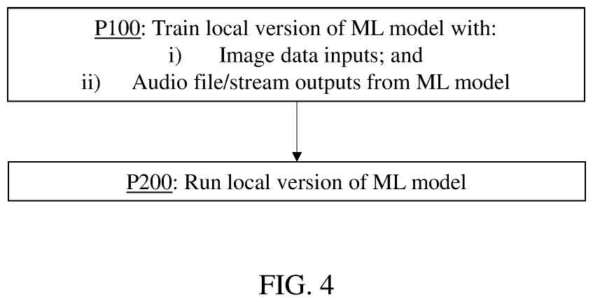

In particular aspects, as illustrated in the flow diagram in FIG. 4, an additional method can include:

P100: training a local version of the ML model 30 (i.e., ML model 30′) running at the audio device 20 or a connected smart device 40 with: (i) image data inputs, and (ii) audio file or stream outputs from the cloud-based ML model 30; and

P200: running the local version of the ML model 30′ in response to receiving subsequent image data after the training.

In certain examples, training can include receiving feedback from a user, and refining the local version of the ML model 30′ based on the received feedback. The local version of the ML model 30′ can be trained in conjunction with running the cloud-based (or otherwise remote) ML model 30.

In certain additional cases, the processor 50 is configured to send data about one or more controllable attributes of the audio device(s) 20 to the ML model 30 to supplement decision making regarding the audio output. In some cases, the controllable attributes are defined in terms of an application programming interface (API), e.g., JSON.

In certain examples, the process of routing the input (including image data 220) through the ML model 30 includes defining a format of a response from the ML model 30, e.g., using a response formatting module. In certain implementations, the response formatting module converts the input 220 into a formatted input that includes the context of the input 220 along with format characteristics of the response. In one example, the format includes an object-based format such as JSON. In particular cases, the formatted input includes one or more keys for indicating a response based on one or more decision layers. For example, the formatted input can include at least three distinct sets of decision layer keys, which may correspond with distinct layers of the ML model 30, e.g., one or more layers in the image based control module 210. In one example, the image based control module 210 includes a plurality of layers corresponding with: i) top level decisions (action routing), ii) wearable audio device type controls (e.g., where audio device 20 is a wearable audio device), iii) speaker or out-loud audio device type controls (e.g., where audio device 20 is a speaker intended to provide out-loud audio), iv) system state changes, v) external API response selection controls (e.g., in selecting responses from a service 320), and/or vi) text summarizer controls.

As noted herein, in contrast to conventional approaches and systems, various implementations include approaches and systems for controlling audio device output using image data and a machine learning (ML) model. In particular cases, the approaches include selecting audio file(s) or stream(s) for output based on image data received via an input. The ML model can be used to determine an audio indication of image data, and selection of the audio file or stream is based on the audio indication. The various disclosed implementations can enhance the user experience, for example, providing for audio content selection using image data such as photos, videos, etc. Further, the experiences enabled by the various disclosed implementations can enhance user engagement and/or satisfaction, providing among other things, a level of amusement not achievable with conventional systems. In any case, the approaches described according to various implementations have the technical effect of enhancing the efficiency and/or accuracy of audio controls in one or more devices.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations.

In some implementations, the host-based elements of the approach are implemented in a software module (e.g., an “App”) that is downloaded and installed on the source/host (e.g., a “smartphone”), in order to provide the controlled audio output aspects according to the approaches described above. In particular cases, functions such as input routing control can be controlled by a centralized interface command, e.g., a command at an interface on one of the audio devices, e.g., audio device(s) 20, 20A, 20B, etc.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

A number of implementations have been described. Nevertheless, it will be understood that additional modifications may be made without departing from the scope of the inventive concepts described herein, and, accordingly, other embodiments are within the scope of the following claims.

We claim:

1. A method comprising:
obtaining image data from an input;
routing the image data through a machine learning (ML) model to determine at least one audio indication of the image data;
selecting an audio file or stream based on the at least one audio indication of the image data; and
initiating audio output of the audio file or stream at an audio device.

2. The method of claim 1, wherein the audio output is initiated in response to selecting the audio file or stream and without an intervening user command.

3. The method of claim 1, wherein the image data is obtained at a smart device connected with the audio device.

4. The method of claim 1, further comprising:
retrieving audio output preferences for a user or a set of users in response to obtaining the image data; and
routing the audio output preferences to the ML model to aid in determining the at least one audio indication of the image data.

5. The method of claim 4, wherein routing the image data and the audio output preferences through the ML model further includes providing a set of instructions to the ML model to select an audio file or stream, wherein the set of instructions are based at least in part on a set of audio device context data.

6. The method of claim 1, wherein initiating the audio output is based at least in part on a set of audio device context data, wherein the audio device context data is stored at the audio device or at a connected smart device.

7. The method of claim 1, wherein the image data includes at least one of photographic data or video data.

8. The method of claim 1, further comprising:
obtaining audio data with the image data, and
adjusting at least one aspect of the audio output based on the audio data.

9. The method of claim 1, wherein the image data is encoded prior to routing to the ML model.

10. The method of claim 1, further comprising:
prompting the user to review the audio file or stream, and
initiating the audio output based upon a response to the prompt.

11. The method of claim 1, wherein the ML model is run on the audio device or a connected smart device.

12. The method of claim 11, wherein the ML model includes a function-limited operational mode.

13. The method of claim 12, wherein in response to detecting a threshold latency in network communication, the method includes running the ML model in the function-limited operational mode on the audio device or the connected smart device.

14. The method of claim 1, wherein the ML model is cloud-based, the method further comprising:
training a local version of the ML model running at the audio device or a connected smart device with: image data inputs, and audio file or stream outputs from the cloud-based ML model; and
running the local version of the ML model in response to receiving subsequent image data after the training.

15. The method of claim 1, wherein the image data is captured at the audio device.

16. The method of claim 15, further comprising prompting a user of the audio device to capture the image data.

17. An audio device comprising:
an electro-acoustic transducer;
at least one microphone; and
a processor coupled with the electro-acoustic transducer and the at least one microphone, the processor programmed to:
rout image data obtained from an input through a machine learning (ML) model to determine at least one audio indication of the image data;
select an audio file or stream based on the audio indication of the image data; and
initiate audio output of the audio file or stream at the electro-acoustic transducer.

18. The audio device of claim 17, wherein the audio output is initiated in response to selecting the audio file or stream and without an intervening user command.

19. The audio device of claim 17, wherein the image data is obtained at a smart device connected with the audio device or by a camera at the audio device.

20. The audio device of claim 17, wherein the processor is further configured to:
retrieve audio output preferences for a user or a set of users in response to obtaining the image data; and
rout the audio output preferences to the ML model to aid in determining the at least one audio indication of the image data,
wherein routing the image data and the audio output preferences through the ML model further includes providing a set of instructions to the ML model to select an audio file or stream, and
wherein the set of instructions are based at least in part on a set of audio device context data.
